(19) United States
(12) Patent Application Publication
(10) Pub. No.: US 2026/0159401 A1
(43) Pub. Date: Jun. 11, 2026

(54) METHOD FOR RAPID SYNTHESIS OF METAL SULFIDES

(71) Applicant: Solid Power Operating, Inc., Louisville, CO (US)

(72) Inventors: Benjamin A. CARLSON, St. Paul, MN (US); Samuel M. OBERWETTER, Lafayette, CO (US); Clara MAUSER, Broomfield, CO (US); Brian E. FRANCISCO, Arvada, CO (US)

(21) Appl. No.: 19/409,273

(22) Filed: Dec. 4, 2025

Related U.S. Application Data
(60) Provisional application No. 63/730,705, filed on Dec. 11, 2024.

(51) Int. Cl. C01B 33/00; C01D 3/04; C01D 15/04; C01G 19/00; C01G 25/00

(52) U.S. Cl. CPC C01B 33/00; C01D 3/04; C01D 15/04; C01G 19/00; C01G 25/00

(57) ABSTRACT

Methods for producing metal sulfides generally include combining an alkali metal sulfide and a metal halide in an aprotic solvent to produce a mixture that includes an alkali metal halide and a metal sulfide. Additional methods include combining a first alkali metal sulfide, a second alkali metal sulfide, and a metal halide in an aprotic solvent to produce a mixture that includes a first alkali metal halide, a second alkali metal halide, and a metal sulfide. The methods may include adding a second solvent to cause an alkali metal halide to precipitate out of the mixture and improve the purity of the metal sulfide.

### CROSS-REFERENCE TO RELATED APPLICATION

This application is related to and claims priority under 35 U.S.C. § 119 from U.S. Provisional Application No. 63/730,705 filed Dec. 11, 2024, titled “Method for Rapid Synthesis of Metal Sulfides,” the entire contents of which are fully incorporated by reference herein for all purposes.

### TECHNICAL FIELD

This application is directed to various processes for forming metal sulfides using alkali metal sulfides, alkali metal halides, and metal halides as reactants.

### BACKGROUND

Advancements in battery and semiconductor technologies are at an all-time high. However, these industries rely heavily on a rather small set of materials belonging to transition metals. Materials like SiS₂ are needed. Historically, this material, and others like it have been difficult to make, requiring large amounts of energy, specialized equipment, or expensive precursor materials to produce.

It is with these observations in mind, among others, that various aspects of the present disclosure were conceived.

### SUMMARY

Provided herein are methods for producing metal sulfides and composites comprising metal sulfides. The methods include combining a first alkali metal sulfide, a second alkali metal sulfide, and a metal halide in an aprotic solvent to produce a solution comprising a metal sulfide and an alkali metal salt. In some embodiments, the method may further include removing the alkali metal salt from the aprotic solvent.

In some embodiments, the methods include combining a first alkali metal salt and a first alkali metal sulfide in an aprotic solvent to produce a mixture comprising a second sulfide and a precipitated second alkali metal salt; adding a metal halide to the mixture to produce a supernatant comprising the first alkali metal salt and a metal sulfide and the aprotic solvent; removing the precipitated second alkali metal salt from the supernatant; adding a second solvent to precipitate the metal sulfide; and recovering the precipitated metal sulfide.

In some embodiments, the methods include combining a first alkali metal sulfide, a second alkali metal sulfide, and a metal halide in an aprotic solvent to form a mixture comprising a first alkali metal halide, a precipitated second alkali metal halide, and a metal sulfide; removing the precipitated second alkali metal halide from the mixture; adding a second solvent to the mixture to precipitate the metal sulfide; and removing the precipitated metal sulfide from the mixture.

In some embodiments, the methods include combining a first alkali metal sulfide, a second alkali metal sulfide, and a metal halide in an aprotic solvent to form a mixture comprising a first alkali metal halide, a precipitated second alkali metal halide, and a metal sulfide; removing the precipitated second alkali metal halide from the mixture; and heating the mixture to remove the aprotic solvent, thereby forming a composite comprising a metal sulfide.

In some embodiments, the methods include combining an alkali metal sulfide and a metal halide in an aprotic solvent to form a mixture; adding a second solvent to the mixture to precipitate the metal sulfide; and removing the precipitated metal sulfide from the mixture.

In some embodiments, the methods include combining an alkali metal sulfide and a metal halide in an aprotic solvent to form a mixture; and heating the mixture to remove the aprotic solvent, thereby forming a composite comprising a metal sulfide.

### BRIEF DESCRIPTION OF DRAWINGS

The present disclosure may be understood by reference to the following detailed description taken in conjunction with the drawings briefly described below. It is noted that, for purposes of illustrative clarity, certain elements in the drawings may not be drawn to scale.

FIGS. 1A, 1B, and 1C are schematic illustrations of synthesis processes according to embodiments of the present disclosure.

FIGS. 2A, 2B, 2C, and 2D are schematic illustrations of synthesis processes according to embodiments of the present disclosure.

FIGS. 3A, 3B, and 3C are schematic illustrations of synthesis processes according to embodiments of the present disclosure.

FIG. 4A shows XRD patterns of the first precipitate formed in Example 1 of the present disclosure.

FIG. 4B shows XRD patterns of the second precipitate formed in Example 1 of the present disclosure.

FIG. 5A shows XRD patterns of the first precipitate formed in Example 2 of the present disclosure.

FIG. 5B shows XRD patterns of the second precipitate formed in Example 2 of the present disclosure.

FIG. 6A shows XRD patterns of the first precipitate formed in Example 3 of the present disclosure.

FIG. 6B shows XRD patterns of the second precipitate formed in Example 3 of the present disclosure.

FIG. 7 shows XRD patterns of the first precipitate formed in Example 4 of the present disclosure.

FIG. 8 shows XRD patterns of the first precipitate formed in Example 5 of the present disclosure.

FIG. 9 shows XRD patterns of the first precipitate formed in Example 6 of the present disclosure.

### DETAILED DESCRIPTION OF ILLUSTRATED EMBODIMENTS

Various aspects of the present invention are disclosed and described, it is to be understood that this invention is not limited to the particular methods, compositions, or materials disclosed herein, but is extended to equivalents thereof as would be recognized by those ordinarily skilled in the relevant arts. It should also be understood that terminology employed herein is used for the purpose of describing particular embodiments only and is not intended to be limiting.

Concentrations, amounts, and other numerical data may be expressed or presented herein in a range format. It is to be understood that such a range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 2 to about 50” should be interpreted to include not only the explicitly recited values of 2 to 50, but also include all individual values and sub-ranges within the indicated range. Thus, included in this numerical range are individual values such as 2, 2.4, 3, 3.7, 4, 5.5, 10, 10.1, 14, 15, 15.98, 20, 20.13, 23, 25.06, 30, 35.1, 38.0, 40, 44, 44.6, 45, 48, and sub-ranges such as from 1-3, from 2-4, from 5-10, from 5-20, from 5-25, from 5-30, from 5-35, from 5-40, from 5-50, from 2-10, from 2-20, from 2-30, from 2-40, from 2-50, etc. This same principle applies to ranges reciting only one numerical value as a minimum or a maximum. Furthermore, such an interpretation should apply regardless of the breadth of the range or the characteristics being described.

As used herein, the term “about” is used to provide flexibility to a numerical range endpoint by providing that a given value may be “a little above” or “a little below” the endpoint. For example, the endpoint may be within 10%, 8%, 5%, 3%, 2%, or 1% of the listed value. Further, for the sake of convenience and brevity and in another example, a numerical range of “about 50 mg/mL to about 80 mg/mL” should also be understood to provide support for the range of “50 mg/mL to 80 mg/mL.”

In this disclosure, the terms “including,” “containing,” and/or “having” are understood to mean comprising, and are open ended terms.

In this disclosure, unless otherwise specified, the term “metal” refers to metalloids, transition metals, or post-transition metals, and alloys or mixtures thereof. It does not refer to alkali metals.

Described herein are various processes for synthesizing a metal sulfide for use in a solid-state electrochemical cell. The methods generally include combining one or more alkali metal sulfides with one or more alkali metal halides in a solvent, causing a reaction to form the metal sulfide in solution, and then collecting the metal sulfide through precipitation of the metal sulfide or removal of the solvent. In some embodiments, a second solvent is added to precipitate the metal sulfide. The methods are discussed in greater detail below.

### Method I

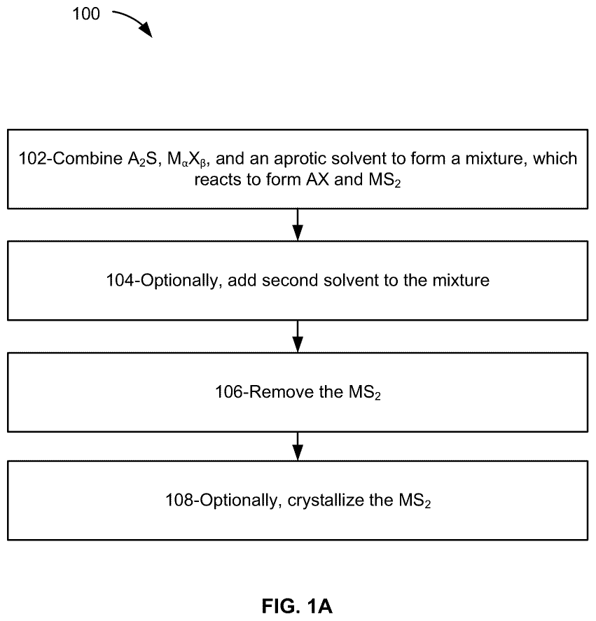

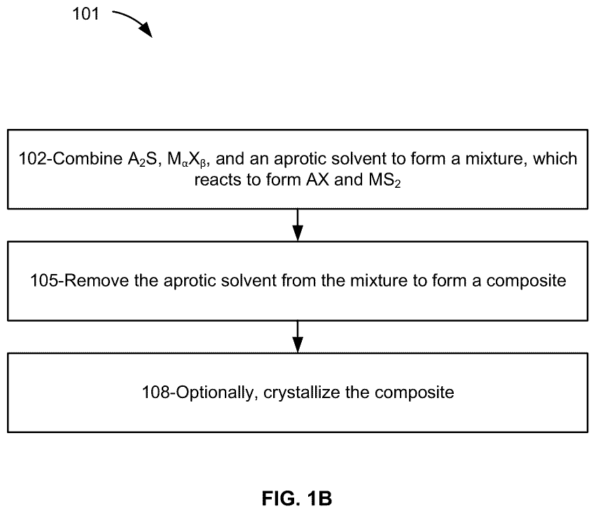

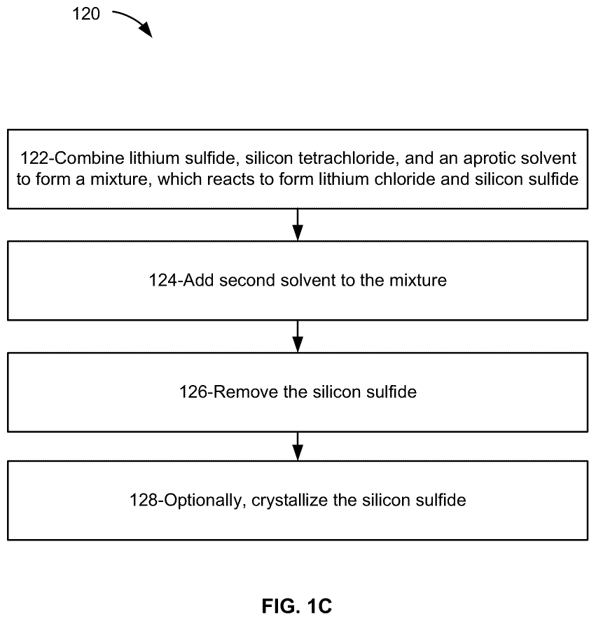

Referring now to FIG. 1A, the present disclosure provides a process 100 of synthesizing a metal sulfide. The process 100 commences at step 102 by combining an alkali metal sulfide and a metal halide in an aprotic solvent, thereby causing a reaction to occur. The reaction results in the formation a metal sulfide and an alkali metal halide dissolved in the solvent. The metal sulfide may form a precipitate or it may be dissolved in the aprotic solvent, depending on the aprotic solvent used. In embodiments in which the metal sulfide is dissolved in the aprotic solvent, the method proceeds to step 104 in which a second solvent, which acts as an anti-solvent, may be added to the mixture that causes the metal sulfide to precipitate. Once the metal sulfide is precipitated, the method proceeds to step 106 in which the precipitated metal sulfide is removed from the aprotic solvent by filtration, decanting, centrifugation, gravity settling, or other methods known in the art or any combination thereof. The method may then proceed to step 108 in which the metal sulfide may be crystallized.

In some embodiments, such as the process described in FIG. 1B, the process 101 may include step 105 removing the aprotic solvent from the mixture to form a composite. This process 101 may be conducted in cases wherein the metal sulfide is precipitated or dissolved in the aprotic solvent. Steps 102 and 108 in process 101 may be conducted as described above with respect to process 100.

The general reaction when only a single solvent is required is:
1. First reaction in first solvent

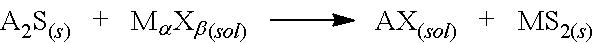

2. Collect precipitated metal sulfide

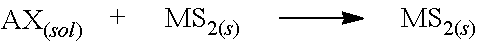

The general reaction when a second solvent is required is:
1. First reaction in first solvent

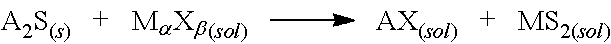

2. Add second solvent

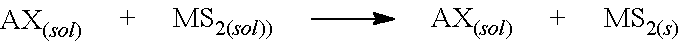

3. Collect precipitated metal sulfide

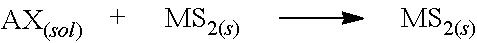

In the above reactions, A₂S refers to an alkali metal sulfide. M_{α}X_{β} refers to a metal halide. AX refers to an alkali metal halide. MS₂ refers to a metal sulfide.

In the reactions above, α may be a number from about 1 to about 5. In some embodiments, α may be about 1.0, about 1.1, about 1.2, about 1.3, about 1.4, about 1.5, about 1.6, about 1.7, about 1.8, about 1.9, about 2.0, about 2.1, about 2.2, about 2.3, about 2.4, about 2.5, about 2.6, about 2.7, about 2.8, about 2.9, about 3.0, about 3.1, about 3.2, about 3.3, about 3.4, about 3.5, about 3.6, about 3.7, about 3.8, about 3.9, about 4.0, about 4.1, about 4.2, about 4.3, about 4.4, about 4.5, about 4.6, about 4.7, about 4.8, about 4.9, or about 5.0.

In the reactions above, β may be a number from about 4 to about 12. In some embodiments, β may be about 4, about 5, about 6, about 7, about 8, about 9, about 10, about 11, or about 12.

In the above reactions, A is an alkali metal or a combination of alkali metals (e.g., Li—Na or Li—K), M may be a metalloid, transition metal, or post-transition metal, and X is a halogen. Non-limiting examples of alkali metals include Li, Na, K, Rb, Cs, and combinations thereof. Non-limiting examples of metalloids include B, Si, Ge, and Sb. Non-limiting examples of transition metals include Ti, W, Sn, Ga, Ag, Mo, Zr, and Hf. Non-limiting examples of post-transition metals include In, Bi, and Tl. Examples of alkali metal halides include but are not limited to LiCl, NaCl, NaBr, NaI, KCl, KBr, KI, and any combination thereof.

The above reactions may be carried out in an aprotic solvent. Aprotic solvents include but are not limited to esters, ethers, nitriles, or hydrocarbons. Esters may include but are not limited to ethyl acetate, ethyl butyrate, isobutyl acetate, butyl acetate, butyl butyrate and butyl propanoate. Ethers may include but are not limited to diethyl ether, diglyme, tetrahydrofuran (THF), dibutyl ether, dipentyl ether, dimethoxyethane (DME), dioxane, or anisole. Nitriles may include but are not limited to acetonitrile, propionitrile, butyronitrile, isobutyronitrile, benzonitrile, decanonitrile, pivalonitrile, valeronitrile. The hydrocarbon solvent may include an alkane, a blend of alkanes, xylene (including para-, meta-, and ortho-xylene), toluene, benzene, heptane, octane, decalin, 1,2,3,4-tetrahydronaphthalene, or combinations thereof. The alkane may include an alkane having from 4 to 20 carbon atoms. The hydrocarbon solvent may include alkenes, alkynes, or a combination thereof, including but not limited to those with linear, branched, or ring structures and boiling points between 30° C. and 250° C. In some embodiments, the aprotic solvent may include DMSO, acetone, DMA, chloroform, or methyl dichloride.

The second solvent used in this reaction may include but is not limited to esters, ethers, nitriles, or hydrocarbons. Esters may include but are not limited to ethyl acetate, ethyl butyrate, isobutyl acetate, butyl acetate, butyl butyrate and butyl propanoate. Ethers may include but are not limited to diethyl ether, diglyme, tetrahydrofuran (THF), dibutyl ether, dipentyl ether, dimethoxyethane (DME), dioxane, or anisole. Nitriles may include but are not limited to acetonitrile, propionitrile, butyronitrile, isobutyronitrile, benzonitrile, decanonitrile, pivalonitrile, valeronitrile. The hydrocarbon solvent may include an alkane, a blend of alkanes, xylene (including para-, meta-, and ortho-xylene), toluene, benzene, heptane, octane, decalin, 1,2,3,4-tetrahydronaphthalene, or combinations thereof. The second solvent may be one or more of DMSO, acetone, DMA, chloroform, methyl dichloride, or pyridine.

In preferred embodiments, the second solvent and the aprotic solvent are not the same. In other embodiments, the second solvent and the aprotic solvent are the same solvent. For example, in one example, the aprotic solvent and the second solvent include pyridine.

Step 102 includes combining the alkali metal sulfide, the metal halide, and the aprotic solvent to form a mixture. This step may further include stirring, mixing, milling, or grinding the material to form a homogeneous mixture and to ensure adequate contact between the alkali metal sulfide and the metal halide to maximize the conversion of the reaction. The mixing may take place for as long as required to dissolve the metal halide and the alkali metal sulfide in the aprotic solvent. Mixing may be accomplished using a shaft mixer, magnetic stirrer, or other mixing devices known in the art. Step 102 may be carried out as a batch process or as a continuous process.

The weight ratio of solids to the aprotic solvent in the mixture may be from about 90:10 to about 10:90, such as from about 90:10 to about 75:25, about 90:10 to about 50:50, about 90:10 to about 25:75, about 90:10 to about 10:90, about 75:25 to about 10:90, about 50:50 to about 10:90, about 25:75 to about 10:90, or about 75:25 to about 25:75. As another example, the weight ratio of solids to the aprotic solvent in the mixture may be about 90:10, 80:20, 70:30, 60:40, 50:50, 40:60, 30:70, 20:80, or about 10:90.

In some embodiments, the combining may be conducted at an elevated temperature to expedite dissolution of the metal halide and the alkali metal sulfide. However, the temperature should not be so high as to drive the formation of undesirable materials or so low as to suppress the solubility of one or more of the alkali metal sulfide or hydrosulfide to the point of halting the reaction. In some aspects, the combining may be performed at a temperature from about −50° C. to about 120° C., about −40° C. to about 100° C., about −30° C. to about 80° C., or about −20° C. to about 60° C. As another example, the combining may be performed at a temperature of about −50° C., −40°C., −30°C., −20°C., −10°C., 0° C., 10° C., 20° C., 30° C., 40° C., 50° C., 60° C., 70° C., 80° C., 90° C., 100° C., 110° C., or about 120° C.

Step 104 is optional and includes adding the second solvent to the mixture. A volume of the second solvent may be added to the mixture immediately or over a period of time (e.g., dropwise). This step may further include mixing, milling, or grinding the material to incorporate the second solvent to ensure it is adequately mixed and causes precipitation of all or substantially all (e.g., greater than 95%) of the metal sulfide. The second solvent and/or the mixture may be heated to increase the speed of the reaction. The second solvent and/or the mixture may be heated to a temperature of about 25° C. to about 100° C.

The amount of second solvent added to the mixture may be from about 5% to about 500% of the weight of the aprotic solvent in the mixture. For example, the amount of second solvent added to the mixture may be from about 5% to about 25%, about 5% to about 50%, about 5% to about 75%, about 5% to about 100%, about 5% to about 250%, about 5% to about 500%, about 25% to about 500%, about 50% to about 500%, about 75% to about 500%, about 100% to about 500%, or about 250% to about 500% of the weight of the aprotic solvent in the mixture. As another example, the amount of second solvent added to the mixture may be about 5%, 10%, 15%, 20%, 25%, 30%, 35%, 40%, 45%, 50%, 55%, 60%, 65%, 70%, 75%, 80%, 85%, 90%, 95%, 100%, 120%, 140%, 160%, 180%, 200%, 250%, 300%, 350%, 400%, 450%, or about 500% of the weight of the aprotic solvent in the mixture.

Step 105 is optional and includes removing the aprotic solvent from the mixture to form a composite. Step 105 is performed when the aprotic solvent is chosen such that both the alkali metal halide and the metal sulfide are soluble in the aprotic solvent and no second solvent is added to cause the metal sulfide to precipitate. Removing the aprotic solvent may be performed by drying the solvent. This may be accomplished in an inert atmosphere at room temperature, or an elevated temperature may be applied to expedite evaporation of the solvent. For example, step 105 may be accomplished at a temperature from about 25° C. to about 200° C., such as from about 25° C. to about 50° C., about 25° C. to about 150° C., about 25° C. to about 200° C., about 50° C. to about 200° C., about 100° C. to about 200° C., about 150° C. to about 200° C., 25° C., 50° C., 75° C., 100° C., 125° C., 150° C., 175° C., or about 200° C.

Step 106 includes removing the precipitated metal sulfide from the mixture including the alkali metal halide, the metal sulfide, the aprotic solvent, optionally the second solvent, and optionally any unreacted metal halide or alkali metal sulfide remaining in the mixture. The removal may be accomplished by filtration, decanting, centrifugation, gravity settling, or other methods known in the art or any combination thereof. In a preferred embodiment, filtration is used. The filter may be any filter known in the art suitable for removing solids from a solvent.

In some embodiments, the process may further include washing and/or drying the metal sulfide after it is removed in step 106.

Step 108 is optional and includes crystallizing the filtered metal sulfide or the composite in an inert atmosphere. The crystallization may be performed in a crystallizer, an oven, a kiln, or another apparatus known in the art of crystallization. The temperature used during step 708 may be from about 25° C. to about 900° C., about 200° C. to about 700° C., or about 300° C. to about 500° C. For example, the temperature during step 708 may be about 25° C., 50° C., 75° C., 100° C., 150° C., 200° C., 250° C., 300° C., 350° C., 400° C., 450° C., 500° C., 550° C., 600° C., 650° C., 700° C., 750° C., 800° C., 850° C., or about 900° C.

This process may further sinter the metal sulfide or the composite containing the metal sulfide, particularly if the temperature during step 108 is greater than or equal to 300° C.

In one embodiment, as described in FIG. 1C, the first step 122 of the process includes forming a mixture of lithium sulfide and silicon chloride in an aprotic solvent. Next, the lithium sulfide and the silicon chloride react in a metathesis reaction to form lithium chloride and silicon sulfide. A suitable aprotic solvent is one in which the alkali metal halide is soluble and does not react deleteriously with the lithium sulfide, the silicon chloride, or the silicon sulfide. In some examples, the aprotic solvent comprises acetonitrile or ethyl acetate. The lithium chloride and silicon sulfide form a soluble complex in the aprotic solvent. Next, in step 124, a second organic solvent is then added in which the lithium chloride is soluble. In some examples, the second solvent is pyridine. This solvent addition, surprisingly, causes the silicon sulfide to precipitate from the solution while keeping the lithium chloride fully dissolved. The resulting precipitated silicon sulfide may be removed in step 126. Further processing may include washing, drying, or crystallizing the silicon sulfide in step 128. The reactions are:
1. First reaction in solvent

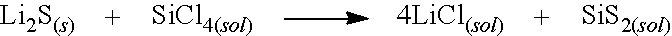

2. Addition of second solvent

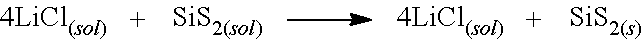

3. Remove metal sulfide product

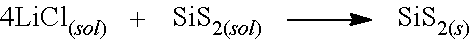

In some cases, the metal sulfide may only appreciably form a soluble complex with lithium halides, and, as such, using a non-lithium alkali metal sulfide, such as Na₂S or K₂S, may form a composite of the metal sulfide and a non-lithium alkali metal halide, such as NaCl or KCl. Surprisingly, it was discovered that by using a blend of alkali metal sulfides where at least one alkali metal sulfide was Li₂S (such as a blend of Na₂S or K₂S with Li₂S), a soluble complex may be formed with the produced lithium halide and metal sulfide. By forming this soluble complex, the metal sulfide can easily be separated from the non-lithium alkali metal halide.

### Method II

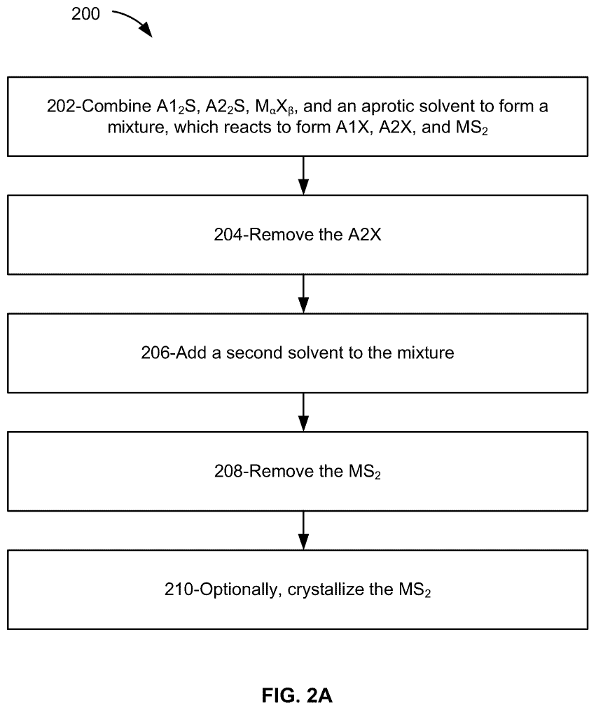

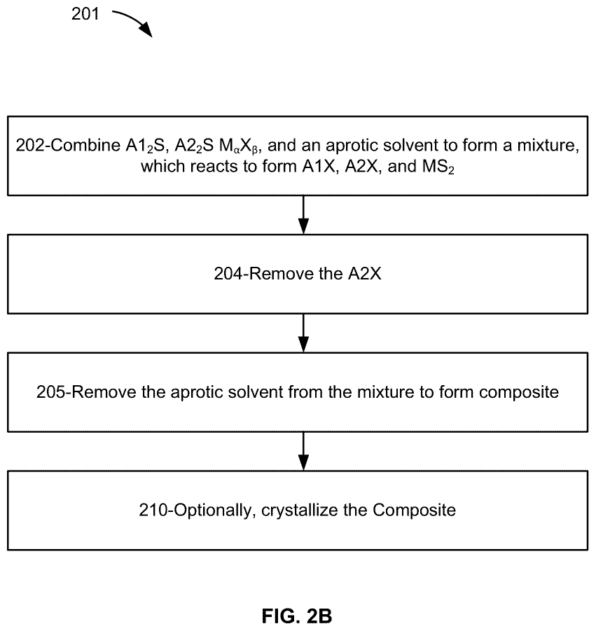

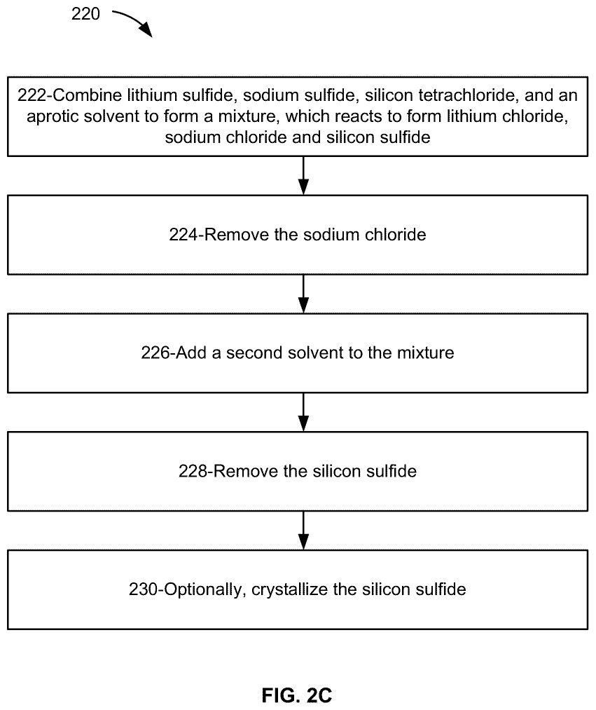

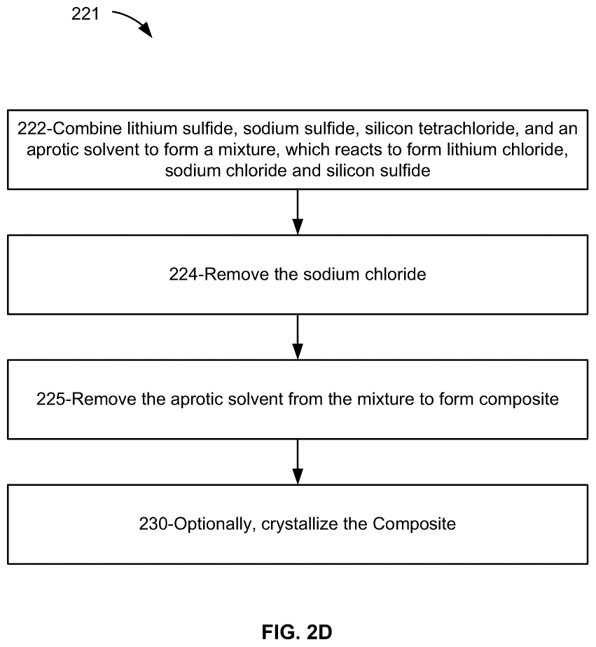

Referring now to FIG. 2A, a second process 200 for synthesizing a metal sulfide. The method 200 commences at step 202 by combining a first alkali metal sulfide, a second alkali metal sulfide, and a metal halide in an aprotic solvent, thereby causing a reaction to occur. The reaction results in the formation of a metal sulfide dissolved in the aprotic solvent, a first alkali metal halide dissolved in the solvent, and one or more precipitated alkali metal byproducts, including a second alkali metal halide. At step 204, the one or more byproducts including the second alkali metal halide may be removed from the aprotic solvent by filtration, decanting, centrifugation, gravity settling, or other methods known in the art or any combination thereof. The process 200 then proceeds to step 206, in which a second solvent is added to the mixture to precipitate the metal sulfide dissolved in the aprotic solvent. Once the metal sulfide is precipitated, the method proceeds to step 208 in which the precipitated metal sulfide is removed from the aprotic solvent by filtration, decanting, centrifugation, gravity settling, or other methods known in the art or any combination thereof. The method may then proceed to step 210 in which the metal sulfide may be crystallized.

In some embodiments, such as the process described in FIG. 2B, the process 201 may include step 205 removing the aprotic solvent from the mixture to form a composite. This process 201 may be conducted in cases wherein the metal sulfide is precipitated or dissolved in the aprotic solvent. Steps 202, 204, and 210 in process 201 may be conducted as described above with respect to process 200.

The general reaction when a second solvent is required is:
1. First reaction in solvent

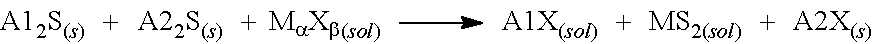

2. Remove the byproduct

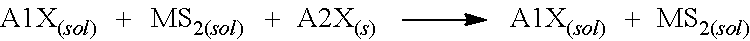

3. Addition of second solvent

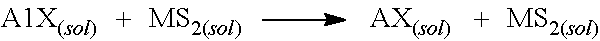

4. Collect precipitated metal sulfide

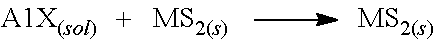

The general reaction when a second solvent is not required is:
1. First reaction in solvent

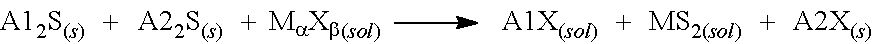

2. Remove the byproduct

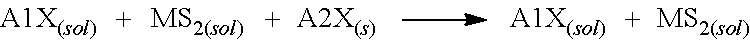

3. Remove solvent and form composite

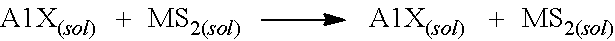

A1₂S and A2₂S each refer to alkali metal sulfides. M_{α}X_{β} refers to a metal halide. A1X and A2X each refer to alkali metal halides. MS₂ refers to a metal sulfide.

In the reactions above, α may be a number from about 1 to about 5. In some embodiments, α may be about 1.0, about 1.1, about 1.2, about 1.3, about 1.4, about 1.5, about 1.6, about 1.7, about 1.8, about 1.9, about 2.0, about 2.1, about 2.2, about 2.3, about 2.4, about 2.5, about 2.6, about 2.7, about 2.8, about 2.9, about 3.0, about 3.1, about 3.2, about 3.3, about 3.4, about 3.5, about 3.6, about 3.7, about 3.8, about 3.9, about 4.0, about 4.1, about 4.2, about 4.3, about 4.4, about 4.5, about 4.6, about 4.7, about 4.8, about 4.9, or about 5.0.

In the reactions above, β may be a number from about 4 to about 12. In some embodiments, β may be about 4, about 5, about 6, about 7, about 8, about 9, about 10, about 11, or about 12.

In the above reactions, A1 is one or more alkali metals (e.g., Li₂, Li—Na, or Li—K); A2 is one or more alkali metals; M may be a metalloid, transition metal, or post-transition metal; and X is a halogen. Non-limiting examples of alkali metals include Li, Na, K, Rb, and Cs. Non-limiting examples of metalloids include B, Si, Ge, and Sb. Non-limiting examples of transition metals include Ti, W, Ag, Mo, Zr, and Hf. Non-limiting examples of post-transition metals include In, Bi, Sn, Ga, and Tl. Examples of alkali metal halides include but are not limited to LiCl, NaCl, NaBr, NaI, KCl, KBr, KI, and any combination thereof.

In some embodiments, the molar ratio of the first alkali metal sulfide to the second alkali metal sulfide may range from 99:1 to 5:95.

The above reactions may be carried out in an aprotic solvent. Aprotic solvents include but are not limited to esters, ethers, nitriles, or hydrocarbons. Esters may include but are not limited to ethyl acetate, ethyl butyrate, isobutyl acetate, butyl acetate, butyl butyrate and butyl propanoate. Ethers may include but are not limited to diethyl ether, diglyme, tetrohydrofuran (THF), dibutyl ether, dipentyl ether, dimethoxyethane (DME), dioxane, or anisole. Nitriles may include but are not limited to acetonitrile, propionitrile, butyronitrile, isobutyronitrile, benzonitrile, decanonitrile, pivalonitrile, valeronitrile. The hydrocarbon solvent may include an alkane, a blend of alkanes, xylene (including para-, meta-, and ortho-xylene), toluene, benzene, heptane, octane, decalin, 1,2,3,4-tetrahydronaphthalene, or combinations thereof. The alkane may include an alkane having from 4 to 20 carbon atoms. In some cases, the hydrocarbon solvent may include alkenes, alkynes, or a combination thereof, including but not limited to those with linear, branched, or ring structures and boiling points between 30° C. and 250° C. The aprotic solvent may be one or more of DMSO, acetone, DMA, chloroform, or methyl dichloride.

The second solvent used in this reaction may include but is not limited to an ester, ether, nitrile, or hydrocarbon. Esters may include but are not limited to ethyl acetate, ethyl butyrate, isobutyl acetate, butyl acetate, butyl butyrate and butyl propanoate. Ethers may include but are not limited to diethyl ether, diglyme, tetrohydrofuran (THF), dibutyl ether, dipentyl ether, dimethoxyethane (DME), dioxane, or anisole. Nitriles may include but are not limited to acetonitrile, propionitrile, butyronitrile, isobutyronitrile, benzonitrile, decanonitrile, pivalonitrile, valeronitrile. The hydrocarbon solvent may include an alkane, a blend of alkanes, xylene (including para-, meta-, and ortho-xylene), toluene, benzene, heptane, octane, decalin, 1,2,3,4-tetrahydronaphthalene, or combinations thereof. The second solvent may be one or more of DMSO, acetone, DMA, chloroform, methyl dichloride, or pyridine.

In preferred embodiments, the second solvent and the aprotic solvent are not the same.

Step 202 includes combining the first alkali metal sulfide, the second alkali metal sulfide, the metal halide, and the aprotic solvent to form a mixture. This step may further include stirring, mixing, milling, or grinding the material to form a homogeneous mixture and to ensure adequate contact between the alkali metal sulfide and the metal halide to maximize the conversion of the reaction. The mixing may take place for as long as required to dissolve the metal halide and the alkali metal sulfide in the aprotic solvent. Mixing may be accomplished using a shaft mixer, magnetic stirrer, or other mixing devices known in the art. Step 202 may be carried out as a batch process or as a continuous process.

The weight ratio of solids to the aprotic solvent in the mixture may be from about 90:10 to about 10:90, such as from about 90:10 to about 75:25, about 90:10 to about 50:50, about 90:10 to about 25:75, about 90:10 to about 10:90, about 75:25 to about 10:90, about 50:50 to about 10:90, about 25:75 to about 10:90, or about 75:25 to about 25:75. As another example, the weight ratio of solids to the aprotic solvent in the mixture may be about 90:10, 80:20, 70:30, 60:40, 50:50, 40:60, 30:70, 20:80, or about 10:90.

In some embodiments, the combining may be conducted at an elevated temperature to expedite dissolution of the metal halide and the first and second alkali metal sulfides. However, the temperature should not be so high as to drive the formation of undesirable materials or so low as to suppress the solubility of one or more of the first or second alkali metal sulfide to the point of halting the reaction. In some aspects, the combining may be performed at a temperature from about −50° C. to about 120° C., about −40° C. to about 100° C., about −30° C. to about 80° C., or about −20° C. to about 60° C. As another example, the combining may be performed at a temperature of about −50° C., −40°C., −30°C., −20°C., −10°C., 0° C., 10° C., 20° C., 30° C., 40° C., 50° C., 60° C., 70° C., 80° C., 90° C., 100° C., 110° C., or about 120° C.

Step 204 includes removing the precipitated second alkali metal halide and any other precipitated byproducts from the mixture including the first alkali metal halide, the metal sulfide, the aprotic solvent, and optionally any unreacted metal halide, first alkali metal sulfide, or second alkali metal sulfide remaining in the mixture. The removal may be accomplished by filtration, decanting, centrifugation, gravity settling, or other methods known in the art or any combination thereof. In a preferred embodiment, filtration is used. The filter may be any filter known in the art suitable for removing solids from a solvent.

Step 205 is only conducted during process 201 and includes removing the aprotic solvent from the mixture to form a composite. Step 205 is performed when the aprotic solvent is chosen such that both the first alkali metal halide and the metal sulfide are soluble in the aprotic solvent and no second solvent is added to cause the metal sulfide to precipitate. Removing the aprotic solvent may be performed by drying the solvent. This may be accomplished at room temperature, or an elevated temperature may be applied to expedite evaporation of the solvent. For example, step 205 may be accomplished at a temperature from about 25° C. to about 200° C., such as from about 25° C. to about 50° C., about 25° C. to about 150° C., about 25° C. to about 200° C., about 50° C. to about 200° C., about 100° C. to about 200° C., about 150° C. to about 200° C., 25° C., 50° C., 75° C., 100° C., 125° C., 150° C., 175° C., or about 200° C.

Step 206 is only conducted during process 200 and includes adding the second solvent to the mixture. A volume of the second solvent may be added to the mixture immediately or over a period of time (e.g., dropwise). This step may further include mixing, milling, or grinding the material to incorporate the second solvent to ensure it is adequately mixed and causes precipitation of all or substantially all (e.g., greater than 95%) of the metal sulfide. The second solvent and/or the mixture may be heated to increase the speed of the reaction. The second solvent and/or the mixture may be heated to a temperature of about 25° C. to about 100° C.

The amount of second solvent added to the mixture may be from about 5% to about 500% of the weight of the aprotic solvent in the mixture. For example, the amount of second solvent added to the mixture may be from about 5% to about 25%, about 5% to about 50%, about 5% to about 75%, about 5% to about 100%, about 5% to about 250%, about 5% to about 500%, about 25% to about 500%, about 50% to about 500%, about 75% to about 500%, about 100% to about 500%, or about 250% to about 500% of the weight of the aprotic solvent in the mixture. As another example, the amount of second solvent added to the mixture may be about 5%, 10%, 15%, 20%, 25%, 30%, 35%, 40%, 45%, 50%, 55%, 60%, 65%, 70%, 75%, 80%, 85%, 90%, 95%, 100%, 120%, 140%, 160%, 180%, 200%, 250%, 300%, 350%, 400%, 450%, or about 500% of the weight of the aprotic solvent in the mixture.

Step 208 is only conducted during process 200 and includes removing the metal sulfide from the mixture including the metal sulfide, the aprotic solvent, the second solvent, the first alkali metal halide, and optionally any unreacted metal halide or alkali metal sulfide remaining in the mixture. The removal may be accomplished by filtration, decanting, centrifugation, or other methods known in the art. In a preferred embodiment, filtration is used. The filter may be any filter known in the art suitable for removing solids from a solvent.

Step 210 is optional in either process 200 or 201 and includes crystallizing the filtered metal sulfide or the composite in an inert atmosphere. The crystallization may be performed in a crystallizer, an oven, a kiln, or another apparatus known in the art of crystallization. The temperature used during step 210 may be from about 25° C. to about 900° C., about 200° C. to about 700° C., or about 300° C. to about 500° C. For example, the temperature during step 210 may be about 25° C., 50° C., 75° C., 100° C., 150° C., 200° C., 250° C., 300° C., 350° C., 400° C., 450° C., 500° C., 550° C., 600° C., 650° C., 700° C., 750° C., 800° C., 850° C., or about 900° C.

This process may further sinter the metal sulfide or the composite containing the metal sulfide, particularly if the temperature during step 210 is greater than or equal to 300° C.

In one embodiment shown in FIG. 2C, the first step 222 of the process 220 includes forming a mixture of lithium sulfide, sodium sulfide, and silicon tetrachloride in an aprotic solvent. Next, the lithium sulfide and sodium sulfide and the silicon chloride react in a metathesis reaction to form lithium chloride, sodium chloride, and silicon sulfide. A suitable aprotic solvent is one in which the lithium chloride is soluble, the sodium chloride is sparingly soluble, and does not react deleteriously with the lithium sulfide, the sodium sulfide, the silicon chloride, or the silicon sulfide. The lithium chloride and silicon sulfide form a soluble complex in the aprotic solvent while the sodium chloride precipitates from solution. The precipitated sodium chloride is separated from the aprotic solvent in step 224 by filtering, centrifuging, decanting, gravity settling, or a combination thereof. A second solvent is then added in step 226. This solvent addition may cause both the silicon sulfide and lithium chloride to precipitate from the solution. If the lithium chloride is sufficiently soluble in the second solvent, only the silicon sulfide may precipitate while keeping the sodium chloride fully dissolved. The resulting precipitated silicon sulfide is removed in step 228 by filtering, centrifuging, decanting, gravity settling, or a combination thereof. Further processing may include washing, drying, or crystallizing the silicon sulfide in step 230. The general reactions are:
1. First reaction in solvent

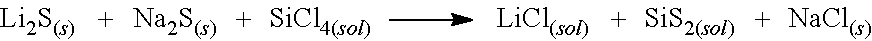

2. Remove byproduct

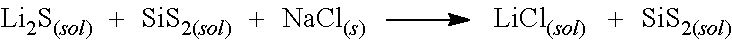

3. Addition of second solvent

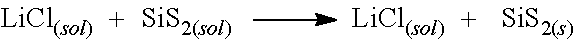

4. Collect precipitated metal sulfide

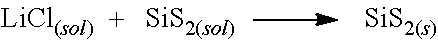

In some embodiments, as shown in process 221 in FIG. 2D, a second solvent may not be added and the solution containing the aprotic solvent, a metal sulfide, and the first alkali metal halide may be heated to remove the aprotic solvent in step 225, producing a composite containing the silicon sulfide and the lithium chloride. This general reaction is shown as follows:
1. First Reaction in Solvent

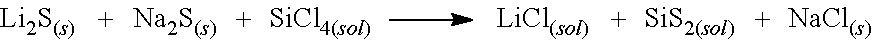

2. Remove byproduct

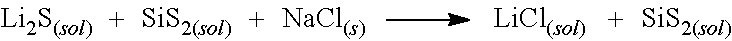

3. Remove solvent and form composite:

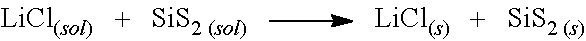

In some embodiments, the metal halide MαXβ may include a metalloid halide such as BCl₃, BBr₃, BI₃, SiF₄, SiCl₄, SiCl₃, Si₂Cl₆, SiBr₄, SiBrCl₃, SiBr₂Cl₂, SiI₄, GeF₄, GeCl₄, GeBr₄, GeI₄, GeF₂, GeCl₂, GeBr₂, GeI, SbF₃, SbCl₃, SbBr₃, SbI₃, SbF₅, SbCl₅, TeF₄, Te₂F₁₀, TeF₆, TeCl₂, TeCl₄, TeBr₂, TeBr₄, or TeI₄.

In some embodiments, the metal halide M_{α}X_{β} may include a post-transition metal halide such as AlF₃, AlBr₃, AlI₃, AlCl₃, SnF₄, SnCl₄, SnBr₄, SnI₄, SnF₂, SnCl₂, SnBr₂, SnI₂, BiF₃, BiCl₃, BiBr₃, or BiI₃.

In a further embodiment, the metal halide M_{α}X_{β} may include a transition metal halide such as TiF₄, TiCl₄, ZrCl₄, ZrBr₄, and ZrCl₂.

### Method III

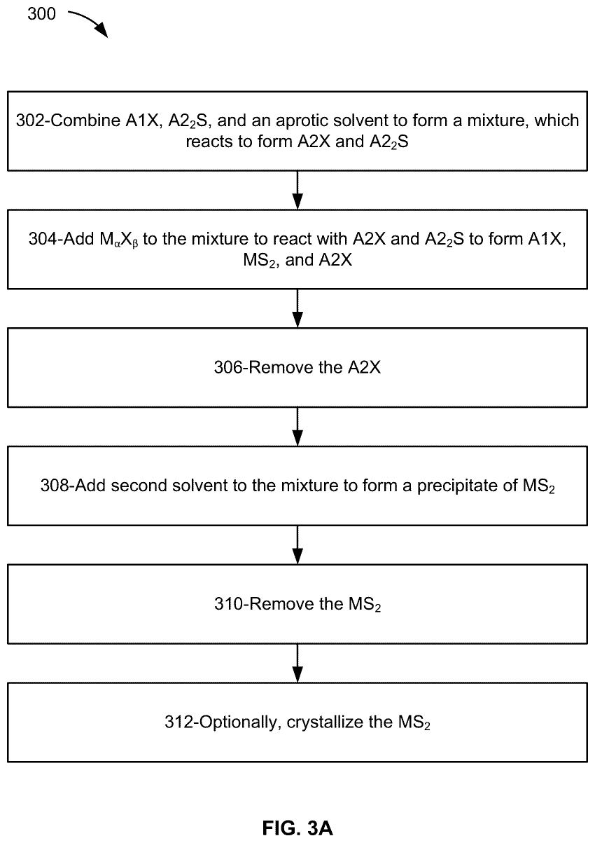

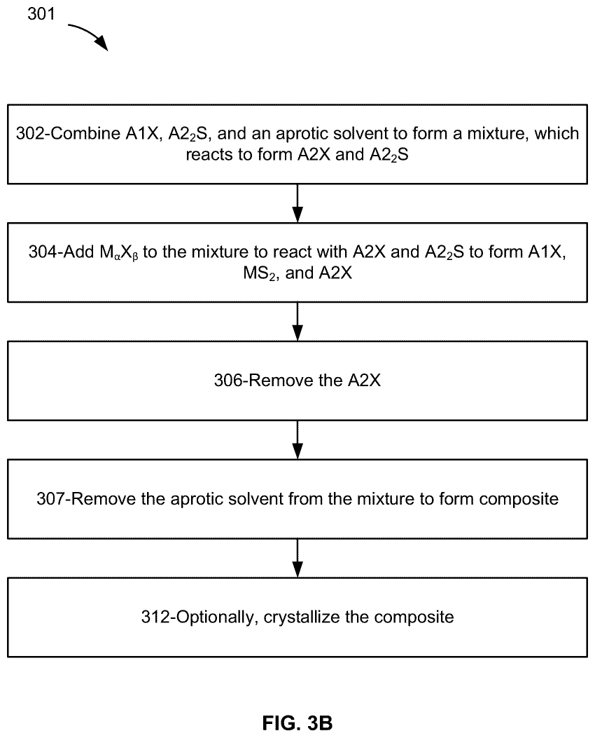

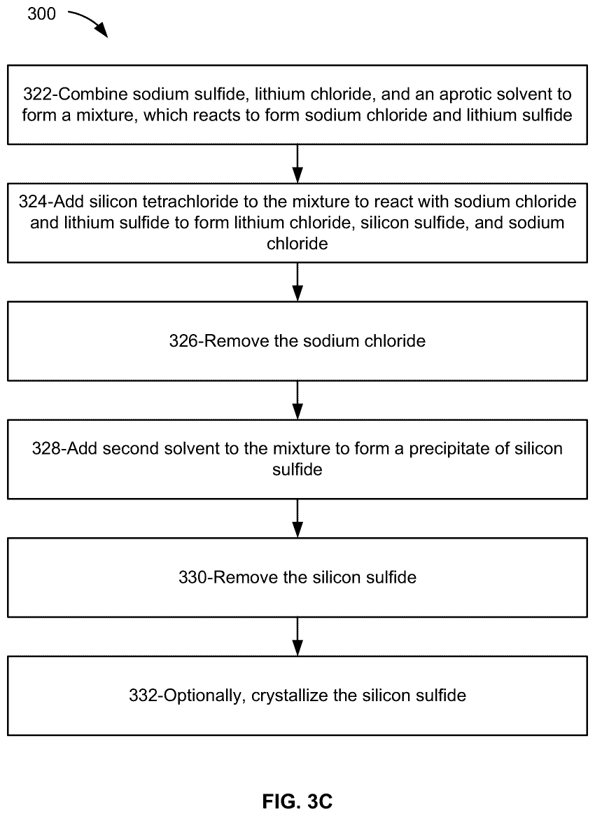

Referring now to FIG. 3A, the present disclosure provides a process 300 of synthesizing a metal sulfide. The process 300 commences at step 302 by combining a first alkali metal halide and a first alkali metal sulfide in an aprotic solvent, thereby causing a metathesis reaction to occur to form a second alkali metal halide and a second alkali metal sulfide. Next, at step 304, a metal halide is added to the mixture to react with the second alkali metal halide and the second alkali metal sulfide to form a metal sulfide dissolved in the aprotic solvent, reform the first alkali metal sulfide dissolved in the aprotic solvent, and one or more second alkali metal byproducts including the second alkali metal halide. At step 306, the one or more byproducts including the second alkali metal halide may be removed from the aprotic solvent by filtration, decanting, centrifugation, gravity settling, or other methods known in the art or any combination thereof. The process 300 then proceeds to step 308, in which a second solvent is added to the mixture to precipitate the metal sulfide dissolved in the aprotic solvent. Once the metal sulfide is precipitated, the method proceeds to step 310 in which the precipitated metal sulfide is removed from the aprotic solvent by filtration, decanting, centrifugation, gravity settling, or other methods known in the art or any combination thereof. The method may then proceed to step 312 in which the metal sulfide may be crystallized.

In some embodiments, such as the process described in FIG. 3B, the process 301 may include step 307 removing the aprotic solvent from the mixture to form a composite. This process 301 may be conducted in cases wherein the metal sulfide is precipitated or dissolved in the aprotic solvent. Steps 302, 304, 306, and 312 in process 301 may be conducted as described above with respect to process 300.

The general reaction when a second solvent is required is:
1. First reaction in solvent

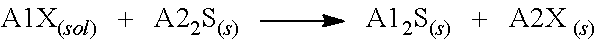

2. Second reaction in solvent

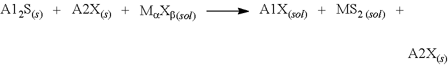

3. Filter to remove byproduct

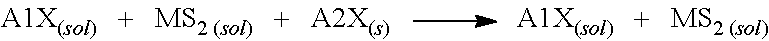

4. Addition of second solvent

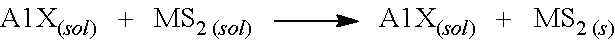

5. Filter to collect precipitated metal sulfide

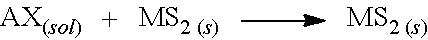

The general reaction when a second solvent is not required is:
1. First reaction in solvent

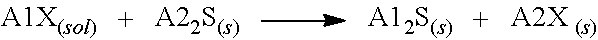

2. Second reaction in solvent

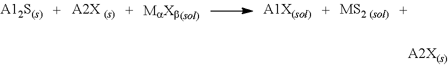

3. Filter to remove byproduct

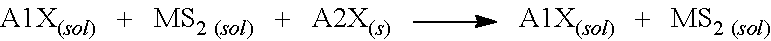

4. Remove solvent to form composite

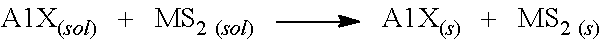

A1₂S and A2₂S refer to the first alkali metal sulfide and the second alkali metal sulfide, respectively. M_{α}X_{β} refers to a metal halide. A1X and A2X refer to the first alkali metal halide and the second alkali metal halide, respectively. MS2 refers to a metal sulfide.

In the reactions above, α may be a number from about 1 to about 5. In some embodiments, α may be about 1.0, about 1.1, about 1.2, about 1.3, about 1.4, about 1.5, about 1.6, about 1.7, about 1.8, about 1.9, about 2.0, about 2.1, about 2.2, about 2.3, about 2.4, about 2.5, about 2.6, about 2.7, about 2.8, about 2.9, about 3.0, about 3.1, about 3.2, about 3.3, about 3.4, about 3.5, about 3.6, about 3.7, about 3.8, about 3.9, about 4.0, about 4.1, about 4.2, about 4.3, about 4.4, about 4.5, about 4.6, about 4.7, about 4.8, about 4.9, or about 5.0.

In the reactions above, β may be a number from about 4 to about 12. In some embodiments, β may be about 4, about 5, about 6, about 7, about 8, about 9, about 10, about 11, or about 12.

In the above reactions, A1 one or more alkali metals (e.g., Li₂, Li—Na or Li—K); A2 is one or more alkali metals; M is a metalloid, transition metal, or post-transition metal; and X is a halogen. Non-limiting examples of alkali metals include Li, Na, K, Rb, Cs, and combinations thereof. Non-limiting examples of metalloids include B, Si, Ge, and Sb. Non-limiting examples of transition metals include Ti, W, Ag, Mo, Zr, and Hf. Non-limiting examples of post-transition metals include In, Bi, Sn, Ga, and Tl. Examples of alkali metal halides include but are not limited to LiCl, NaCl, NaBr, NaI, KCl, KBr, KI, and any combination thereof.

The above reactions may be carried out in an aprotic solvent. Aprotic solvents include but are not limited to esters, ethers, nitriles, or hydrocarbons. Esters may include but are not limited to ethyl acetate, ethyl butyrate, isobutyl acetate, butyl acetate, butyl butyrate and butyl propanoate. Ethers may include but are not limited to diethyl ether, diglyme, tetrohydrofuran (THF), dibutyl ether, dipentyl ether, dimethoxyethane (DME), dioxane, or anisole. Nitriles may include but are not limited to acetonitrile, propionitrile, butyronitrile, isobutyronitrile, benzonitrile, decanonitrile, pivalonitrile, valeronitrile. The hydrocarbon solvent may include an alkane, a blend of alkanes, xylene (including para-, meta-, and ortho-xylene), toluene, benzene, heptane, octane, decalin, 1,2,3,4-tetrahydronaphthalene, or combinations thereof. The alkane may include an alkane having from 4 to 20 carbon atoms. The hydrocarbon solvent may include alkenes, alkynes, and combinations thereof, including but not limited to those with linear, branched, or ring structures and boiling points between 30° C. and 250° C. The aprotic solvent may be one or more of DMSO, acetone, DMA, chloroform, or methyl dichloride.

The second solvent used in this reaction include but are not limited to esters, ethers, nitriles, or hydrocarbons. Esters may include but are not limited to ethyl acetate, ethyl butyrate, isobutyl acetate, butyl acetate, butyl butyrate and butyl propanoate. Ethers may include but are not limited to diethyl ether, diglyme, tetrohydrofuran (THF), Dibutyl ether, dipentyl ether, dimethoxyethane (DME), dioxane, or anisole. Nitriles may include but are not limited to acetonitrile, propionitrile, butyronitrile, isobutyronitrile, benzonitrile, decanonitrile, pivalonitrile, valeronitrile. The hydrocarbon solvent may include an alkane, a blend of alkanes, xylene (including para-, meta-, and ortho-xylene), toluene, benzene, heptane, octane, decalin, 1,2,3,4-tetrahydronaphthalene, or combinations thereof. The second solvent may be one or more of DMSO, acetone, DMA, chloroform, methyl dichloride, or pyridine.

In preferred embodiments, the second solvent and the aprotic solvents are not the same.

Step 302 includes combining the first alkali metal sulfide, the first alkali metal halide, and the aprotic solvent to form a mixture. This step may further include stirring, mixing, milling, or grinding the material to form a homogeneous mixture and to ensure adequate contact between the first alkali metal sulfide and the first alkali metal halide to maximize the conversion of the reaction. The mixing may take place for as long as required to complete the metathesis reaction to form the second alkali metal halide and the second alkali metal sulfide. Mixing may be accomplished using a shaft mixer, magnetic stirrer, or other mixing devices known in the art. Step 302 may be carried out as a batch process or as a continuous process.

The weight ratio of solids to the aprotic solvent in the mixture may be from about 90:10 to about 10:90, such as from about 90:10 to about 75:25, about 90:10 to about 50:50, about 90:10 to about 25:75, about 90:10 to about 10:90, about 75:25 to about 10:90, about 50:50 to about 10:90, about 25:75 to about 10:90, or about 75:25 to about 25:75. As another example, the weight ratio of solids to the aprotic solvent in the mixture may be about 90:10, 80:20, 70:30, 60:40, 50:50, 40:60, 30:70, 20:80, or about 10:90.

In some embodiments, the combining may be conducted at an elevated temperature. In some aspects, the combining may be performed at a temperature from about 50° C. to about 200° C., about 70° C. to about 180° C., or about 90° C. to about 160° C. As another example, the combining may be performed at a temperature of about 50° C., 60° C., 70° C., 80° C., 90° C., 100° C., 110° C., 120° C., 130° C., 140° C., 150° C., 160° C., 170° C., 180° C., 190° C., or about 200° C.

Step 304 includes adding the metal halide to the reaction mixture to react with the second alkali metal halide and the second alkali metal sulfide. The metal halide may be added while continuing the stirring, mixing, milling, or grinding being performed in step 302. Additionally, the heating from step 302 may be continued in step 304.

Step 306 includes removing the precipitated second alkali metal halide and any other precipitated byproducts from the mixture including the first alkali metal halide, the metal sulfide, the aprotic solvent, and optionally any unreacted metal halide, first alkali metal sulfide, or second alkali metal sulfide remaining in the mixture. The removal may be accomplished by filtration, decanting, centrifugation, gravity settling, or other methods known in the art or any combination thereof. In a preferred embodiment, filtration is used. The filter may be any filter known in the art suitable for removing solids from a solvent.

Step 307 is only conducted during process 301 and includes removing the aprotic solvent from the mixture to form a composite. Step 307 is performed when the aprotic solvent is chosen such that both the first alkali metal halide and the metal sulfide are soluble in the aprotic solvent and no second solvent is added to cause the metal sulfide to precipitate. Removing the aprotic solvent may be performed by drying the solvent. This may be accomplished at room temperature, or an elevated temperature may be applied to expedite evaporation of the solvent. For example, step 307 may be accomplished at a temperature from about 25° C. to about 200° C., such as from about 25° C. to about 50° C., about 25° C. to about 150° C., about 25° C. to about 200° C., about 50° C. to about 200° C., about 100° C. to about 200° C., about 150° C. to about 200° C., 25° C., 50° C., 75° C., 100° C., 125° C., 150° C., 175° C., or about 200° C.

Step 308 includes adding the second solvent to the mixture. A volume of the second solvent may be added to the mixture immediately or over a period of time (e.g., dropwise). This step may further include mixing, milling, or grinding the material to incorporate the second solvent to ensure it is adequately mixed and causes precipitation of all or substantially all (e.g., greater than 95%) of the metal sulfide. The second solvent and/or the mixture may be heated to increase the speed of the reaction. The second solvent and/or the mixture may be heated to a temperature of about 25° C. to about 100° C.

The amount of second solvent added to the mixture may be from about 5% to about 500% of the weight of the aprotic solvent in the mixture. For example, the amount of second solvent added to the mixture may be from about 5% to about 25%, about 5% to about 50%, about 5% to about 75%, about 5% to about 100%, about 5% to about 250%, about 5% to about 500%, about 25% to about 500%, about 50% to about 500%, about 75% to about 500%, about 100% to about 500%, or about 250% to about 500% of the weight of the aprotic solvent in the mixture. As another example, the amount of second solvent added to the mixture may be about 5%, 10%, 15%, 20%, 25%, 30%, 35%, 40%, 45%, 50%, 55%, 60%, 65%, 70%, 75%, 80%, 85%, 90%, 95%, 100%, 120%, 140%, 160%, 180%, 200%, 250%, 300%, 350%, 400%, 450%, or about 500% of the weight of the aprotic solvent in the mixture.

Step 310 includes removing the metal sulfide from the mixture including the metal sulfide, the aprotic solvent, the second solvent, the first alkali metal halide, and optionally any unreacted metal halide or alkali metal sulfide remaining in the mixture. The removal may be accomplished by filtration, decanting, centrifugation, or other methods known in the art. In a preferred embodiment, filtration is used. The filter may be any filter known in the art suitable for removing solids from a solvent.

Step 312 is optional and includes crystallizing the filtered metal sulfide in an inert atmosphere. The crystallization may be performed in a crystallizer, an oven, a kiln, or another apparatus known in the art of crystallization. The temperature used during step 312 may be from about 25° C. to about 900° C., about 200° C. to about 700° C., or about 300° C. to about 500° C. For example, the temperature during step 312 may be about 25° C., 50° C., 75° C., 100° C., 150° C., 200° C., 250° C., 300° C., 350° C., 400° C., 450° C., 500° C., 550° C., 600° C., 650° C., 700° C., 750° C., 800° C., 850° C., or about 900° C.

This process may further sinter the metal sulfide or the composite containing the metal sulfide, particularly if the temperature during step 312 is greater than or equal to 300° C.

One embodiment of the process is shown in FIG. 3B. In this embodiment, the first step 322 of the synthesis includes combining sodium sulfide and lithium chloride in an aprotic solvent. During this step, sodium sulfide and lithium chloride react in a metathesis reaction forming sodium chloride and a lithium-containing sulfide. A suitable aprotic solvent is one in which lithium chloride is soluble and sodium chloride is insoluble. Next, in step 324, silicon tetrachloride is added to the solution of lithium-containing sulfide in the aprotic solvent. The lithium-containing sulfide reacts with silicon tetrachloride to form lithium chloride and silicon sulfide in the form of a solubilized complex. Sodium chloride is insoluble in the aprotic solvent and is removed from the aprotic solvent in step 326. A second solvent is added in which the silicon sulfide precipitates in step 328. A suitable second solvent is one in which lithium chloride has a greater solubility than that of the aprotic solvent. The resulting silicon sulfide is now insoluble in the blend of aprotic solvent and second solvent and is removed in step 330. The silicon sulfide may further be washed, dried, or it may be crystallized in step 332.

The general reaction for the embodiment shown in FIG. 3B is shown below:
1. First reaction in solvent

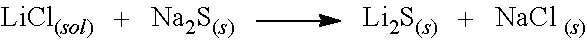

2. Second reaction in solvent

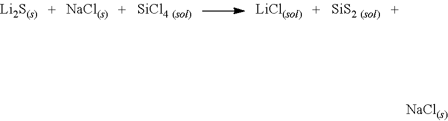

3. Remove byproduct

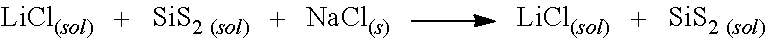

4. Addition of second solvent

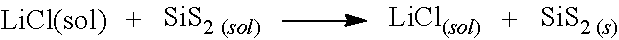

5. Collect precipitated metal sulfide

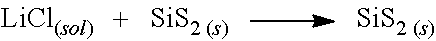

In some embodiments, Na₂S and LiCl are dried and/or in anhydrous form, and the metal sulfide and LiCl are over 94% pure, over 95% pure, over 96% pure, over 97% pure, over 98% pure, over 98.5% pure, over 99% pure, or over 99.5% pure. Further, the metal sulfide and LiCl may be substantially free from lithium oxides (i.e., ≤6.0%, ≤5.0%, ≤4.0%, ≤3.0%, ≤2.0%, ≤1.5%, ≤1.0%, or ≤0.5% by weight lithium oxides).

A surprising benefit to the reactions described herein is that the reaction(s) may occur using technical grade LiCl (e.g., LiCl with purity of 97% or less, 95% or less, 90% or less, 85% or less, 80% or less, 75% or less, 70% or less, 65% or less, 60% or less, 55% or less, or 50% or less). These processes may purify the LiCl by incorporating a low purity “technical grade” LiCl into starting reaction and yielding a LiCl with at least about 2%, at least about 3%, at least about 4%, at least about 5%, at least about 10%, at least about 15%, at least about 20%, at least about 25%, at least about 30%, at least about 35%, at least about 40%, at least about 45%, or at least about 50% greater purity than the LiCl starting material. A further benefit is the ability to use “technical grade” Li₂S (e.g., Li₂S with purity of about 97% or less, 95% or less, 90% or less, 85% or less, 80% or less, 75% or less, 70% or less, 65% or less, 60% or less, 55% or less, or 50% or less) as the metal halide may only react with the Li₂S and not the impurities which may be non-soluble oxides.

Technical grade LiCl may contain impurities that include salts, such as sodium salts, potassium salts, magnesium salts, iron salts, nickel salts, copper salts, silicates, borates, etc. In some aspects, the salts may be chloride salts, such as sodium chloride (NaCl), potassium chloride (KCl), calcium chloride (CaCl₂), magnesium chloride (MgCl₂), iron chloride (FeCl₂), nickel chloride (NiCl₂), and copper chloride (CuCl₂).

Technical grade Li₂S may also contain impurities that include lithium hydroxide (LiOH), lithium sulfate (Li₂SO₄), carbon, lithium carbonate (Li₂CO₃), and lithium oxide (Li₂O).

### ENUMERATED EMBODIMENTS

Embodiment 1: A method of producing a metal sulfide comprising: combining a first alkali metal sulfide, a second alkali metal sulfide, and a metal halide in an aprotic solvent to produce a solution comprising a metal sulfide and an alkali metal salt.
Embodiment 2: The method of embodiment 1, wherein the molar ratio between the first alkali meal sulfide and the second alkali metal sulfide material is from 99:1 to 5:99.
Embodiment 3: The method of embodiment 1 or 2, wherein the first alkali metal sulfide comprises Li₂S, LiNaS, or LiKS.
Embodiment 4: The method of any one of embodiments 1-3, wherein the second alkali metal sulfide comprises Na₂S, K₂S, or Cs₂S.
Embodiment 5: The method of any one of embodiments 1-4, wherein the metal halide comprises boron, silicon, germanium, antimony, tin, zirconium, or tellurium.
Embodiment 6: The method of any one of embodiments 1-5, wherein the metal halide comprises BF₃, BBr₃, BI₃, SiF₄, SiCl₄, SiBr₄, Si₂Cl₆, Si₃Cl₈, GeF₄, GeCl₄, GeBr₄, or GeI₄.
Embodiment 7: The method of any one of embodiments 1-6, wherein the aprotic solvent comprises an ether, ester, nitrile, or imine.
Embodiment 8: The method of any one of embodiments 1-7, wherein the metal sulfide comprises B₂S₃, SiS₂, or GeS₂.
Embodiment 9: The method of any one of embodiments 1-8, wherein the alkali metal salt comprises LiCl.
Embodiment 10: The method of any one of embodiments 1-9, wherein the alkali metal salt further comprises LiF, LiBr, LiI, NaF, NaCl, NaBr, NaI, KF, KCl, KBr, KI, CsF, CsCl, CsBr, or CsI.
Embodiment 11: The method of any one of embodiments 1-10, wherein the combining comprises mixing, grinding, or tumbling.
Embodiment 12: A method of producing a metal sulfide comprising:
   (a) combining a first alkali metal salt and a first alkali metal sulfide in an aprotic solvent to produce a mixture comprising a second sulfide and a precipitated second alkali metal salt;
   (b) adding a metal halide to the mixture to produce a supernatant comprising the first alkali metal salt and a metal sulfide and the aprotic solvent;
   (c) removing the precipitated second alkali metal salt from the supernatant;
   (d) adding a second solvent to precipitate the metal sulfide; and
   (e) recovering the precipitated metal sulfide.
Embodiment 13: The method of embodiment 12, wherein removing the precipitated second alkali metal salt from the supernatant comprises filtering the supernatant.
Embodiment 14: The method of embodiment 12 or 13, wherein the first alkali metal salt comprises LiF, LiCl, LiBr, or LiI.
Embodiment 15: The method of any one of embodiments 12-14, wherein the first alkali metal sulfide comprises Li₂S, Na₂S, LiNaS, LiKS, or K₂S.
Embodiment 16: The method of any one of embodiments 12-15, wherein the aprotic solvent comprises an ether, ester, nitrile, or imine.
Embodiment 17: The method of any one of embodiments 12-16, wherein the second alkali metal sulfide comprises Li₂S, Na₂S, LiNaS, or LiKS.
Embodiment 18: The method of any one of embodiments 12-17, wherein the second alkali metal salt comprises NaF, NaCl, NaBr, NaI, KF, KCl KBr, or KI.
Embodiment 19: The method of any one of embodiments 12-18, wherein the metal halide comprises BF₃, BBr₃, BI₃, SiF₄, SiCl₄, SiBr₄, Si₂Cl₆, Si₃Cl₈, GeF₄, GeCl₄, GeBr₄, or GeI₄.
Embodiment 20: The method of any one of embodiments 12-19, wherein the metal sulfide comprises B₂S₃, SiS₂, or GeS₂.
Embodiment 21: The method of any one of embodiments 12-19, wherein the second solvent comprises a hydrocarbon, ether, ester, nitrile, or imine.
Embodiment 22: A method of producing a metal sulfide comprising:
   combining a first alkali metal sulfide, a second alkali metal sulfide, and a metal halide in an aprotic solvent to form a mixture comprising a first alkali metal halide, a precipitated second alkali metal halide, and a metal sulfide;
   removing the precipitated second alkali metal halide from the mixture;
   adding a second solvent to the mixture to precipitate the metal sulfide; and
   removing the precipitated metal sulfide from the mixture.
Embodiment 23: The method of embodiment 22, wherein removing the precipitated second alkali metal salt from the supernatant comprises filtering the supernatant.
Embodiment 24: The method of embodiment 22 or 23, wherein the first alkali metal sulfide comprises Li₂S, Na₂S, LiNaS, LiKS, or K₂S.
Embodiment 25: The method of any one of embodiments 22-24, wherein the aprotic solvent comprises an ether, ester, nitrile, or imine.
Embodiment 26: The method of any one of embodiments 22-25, wherein the second alkali metal sulfide comprises Li₂S, Na₂S, LiNaS, or LiKS.
Embodiment 27: The method of any one of embodiments 22-26, wherein the metal halide comprises BF₃, BBr₃, BI₃, SiF₄, SiCl₄, SiBr₄, Si₂Cl₆, Si₃Cl₈, GeF₄, GeCl₄, GeBr₄, or GeI₄.
Embodiment 28: The method of any one of embodiments 22-27, wherein the first alkali metal salt comprises LiF, LiCl, LiBr, or LiI.
Embodiment 29: The method of any one of embodiments 22-28, wherein the second alkali metal salt comprises NaF, NaCl, NaBr, NaI, KF, KCl KBr, or KI.
Embodiment 30: The method of any one of embodiments 22-29, wherein the metal sulfide comprises B₂S₃, SiS₂, or GeS₂.
Embodiment 31: A method of producing a composite comprising a metal sulfide comprising:
   combining a first alkali metal sulfide, a second alkali metal sulfide, and a metal halide in an aprotic solvent to form a mixture comprising a first alkali metal halide, a precipitated second alkali metal halide, and a metal sulfide;
   removing the precipitated second alkali metal halide from the mixture; and
   heating the mixture to remove the aprotic solvent, thereby forming a composite comprising a metal sulfide.
Embodiment 32: The method of embodiment 31, wherein removing the precipitated second alkali metal salt from the supernatant comprises filtering the supernatant.
Embodiment 33: The method of embodiment 31 or 32, wherein the first alkali metal sulfide comprises Li₂S, Na₂S, LiNaS, LiKS, or K₂S.
Embodiment 34: The method of any one of embodiments 31-33, wherein the aprotic solvent comprises an ether, ester, nitrile, or imine.
Embodiment 35: The method of any one of embodiments 31-34, wherein the second alkali metal sulfide comprises Li₂S, Na₂S, LiNaS, or LiKS.
Embodiment 36: The method of any one of embodiments 31-35, wherein the metal halide comprises BF₃, BBr₃, BI₃, SiF₄, SiCl₄, SiBr₄, Si₂Cl₆, Si₃Cl₈, GeF₄, GeCl₄, GeBr₄, or GeI₄.
Embodiment 37: The method of any one of embodiments 31-36, wherein the first alkali metal salt comprises LiF, LiCl, LiBr, or LiI.
Embodiment 38: The method of any one of embodiments 31-37, wherein the second alkali metal salt comprises NaF, NaCl, NaBr, NaI, KF, KCl KBr, or KI.
Embodiment 39: The method of any one of embodiments 31-38, wherein the metal sulfide comprises B₂S₃, SiS₂, or GeS₂.
Embodiment 40: A method of producing a metal sulfide comprising:
   combining an alkali metal sulfide and a metal halide in an aprotic solvent to form a mixture;
   adding a second solvent to the mixture to precipitate the metal sulfide; and
   removing the precipitated metal sulfide from the mixture.
Embodiment 41: The method of embodiment 40, wherein removing the precipitated second alkali metal salt from the supernatant comprises filtering the supernatant.
Embodiment 42: The method of embodiment 40 or 41, wherein the aprotic solvent comprises an ether, ester, nitrile, or imine.
Embodiment 43: The method of any one of embodiments 40-42, wherein the alkali metal sulfide comprises Li₂S, Na₂S, LiNaS, LiKS, or K₂S.
Embodiment 44: The method of any one of embodiments 40-43, wherein the metal halide comprises BF₃, BBr₃, BI₃, SiF₄, SiCl₄, SiBr₄, Si₂Cl₆, Si₃Cl₈, GeF₄, GeCl₄, GeBr₄, or GeI₄.
Embodiment 45: The method of any one of embodiments 40-44, wherein the second solvent comprises an ester, ether, nitrile, or hydrocarbon solvent.
Embodiment 46: The method of any one of embodiments 40-45, wherein the metal sulfide comprises B₂S₃, SiS₂, or GeS₂.
Embodiment 47: The method of any one of embodiments 40-46, further comprising heating the mixture to a temperature of about 25° C. to about 100° C. after the second solvent is added.
Embodiment 48: A method of producing a composite comprising a metal sulfide comprising:
   combining an alkali metal sulfide and a metal halide in an aprotic solvent to form a mixture; and
   heating the mixture to remove the aprotic solvent, thereby forming a composite comprising a metal sulfide.
Embodiment 49: The method of embodiment 48, wherein the metal sulfide comprises B₂S₃, SiS₂, or GeS₂.
Embodiment 50: The method of embodiment 48 or 49, wherein the aprotic solvent comprises an ether, ester, nitrile, or imine.
Embodiment 51: The method of any one of embodiments 48-50, wherein the alkali metal sulfide comprises Li₂S, Na₂S, LiNaS, LiKS, or K₂S.
Embodiment 52: The method of any one of embodiments 48-51, wherein the metal halide comprises BF₃, BBr₃, BI₃, SiF₄, SiCl₄, SiBr₄, Si₂Cl₆, Si₃Cl₈, GeF₄, GeCl₄, GeBr₄, or GeI₄.

### EXAMPLES

### Example 1: Li₂S Only

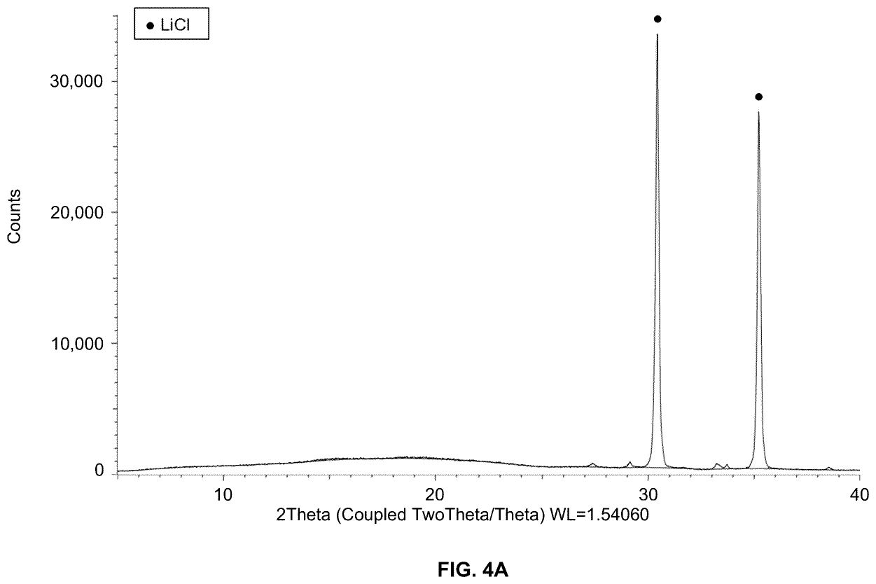

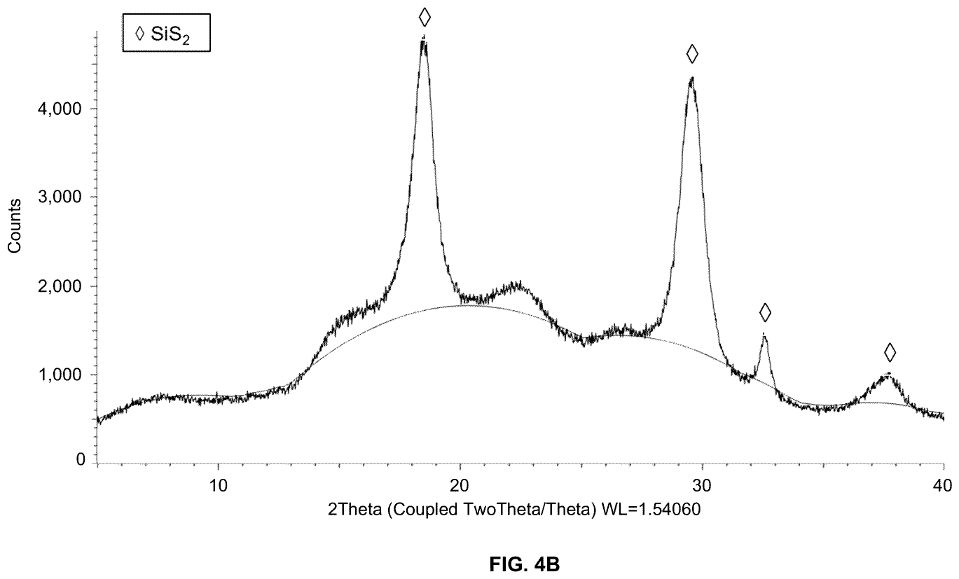

Li₂S and SiCl₄ were added to a glass vial containing 10 mL of acetonitrile where the molar ratio between the Li₂S and the SiCl₄ was 2:1. This mixture was heated to 60° C. and stirred for 4 hours, after which a white precipitate had formed on the bottom of the vial. The precipitate was separated from the solute by way of filtration. The filtered precipitate (the first precipitate) was heated to a temperature of 100° C. while under vacuum conditions. The dried first precipitate powder was then scanned using an X-ray diffractometer (XRD) and was identified to be LiCl as shown in FIG. 4A.

The solute was added back to the glass vial. Pyridine was added to the glass vial at a volume ratio of 50:50. After the addition of the pyridine, a white powder (the second precipitate) precipitated out of solution. The white precipitate was separated from the solute by way of filtering. The filtered second precipitate powder was then heated to 450° C. for 1 hour while under vacuum conditions. The heated second precipitate powder was then scanned using an X-ray diffractometer (XRD) and was identified to be SiS₂ as shown in FIG. 4B.

### Example 2: Li₂S and Na₂S

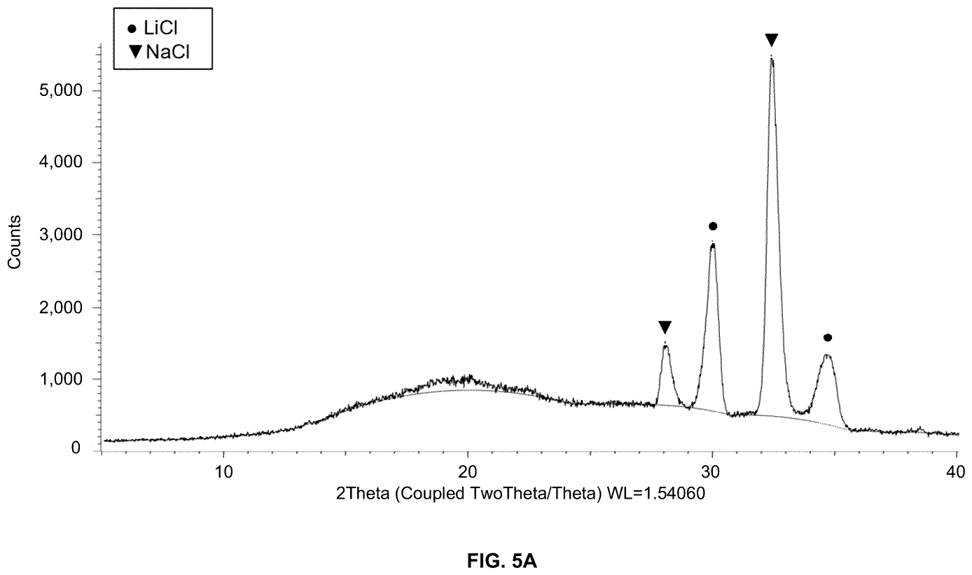

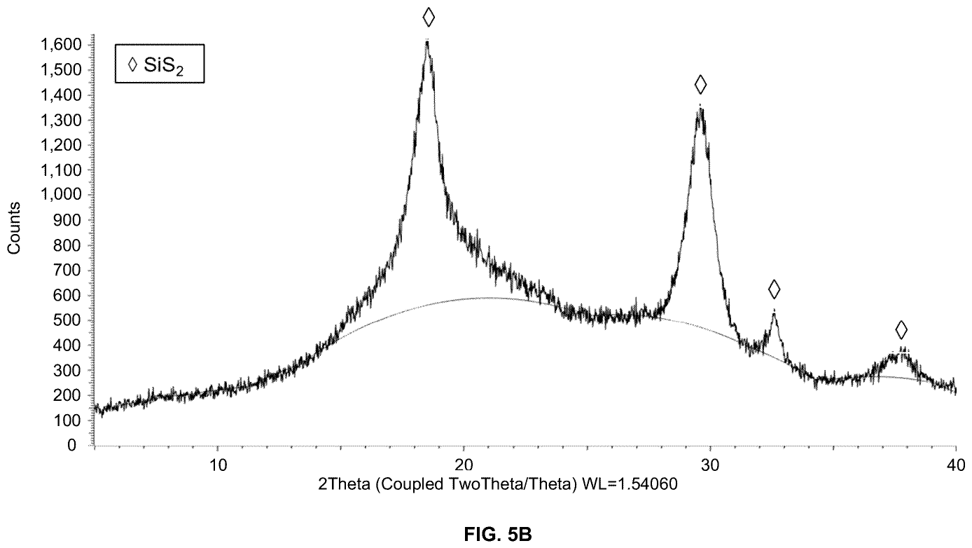

Example 2 was conducted in the same manner as Example 1 except the Li₂S was replaced with blend of Li₂S and Na₂S and the two materials were blended at a 50:50 molar ratio. The dried first precipitate powder was identified to be LiCl and NaCl using an X-ray diffractometer (XRD), as shown in FIG. 5A.

The heated second precipitate powder was identified as SiS₂ using an X-ray diffractometer (XRD), as shown in FIG. 5B.

### Example 3: (LiCl+Na₂S)+SiCl₄

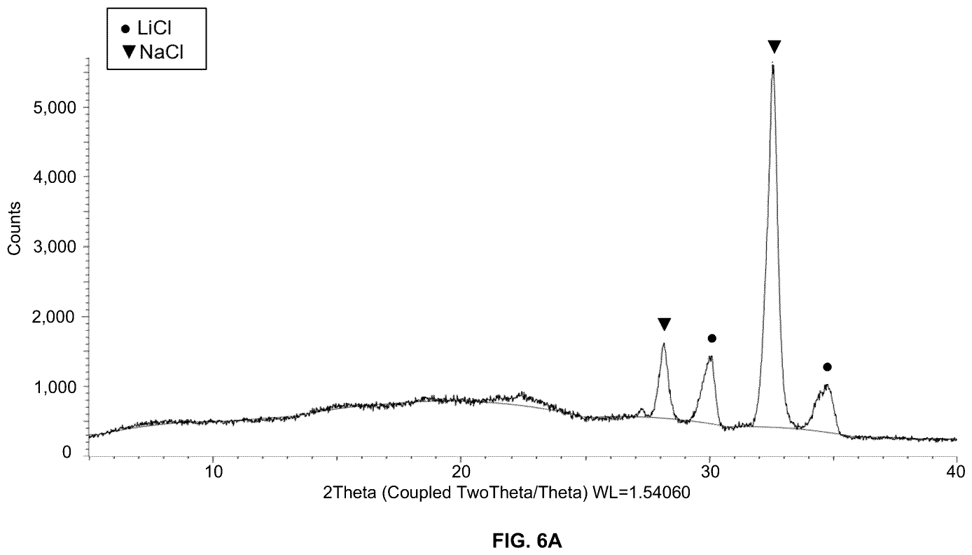

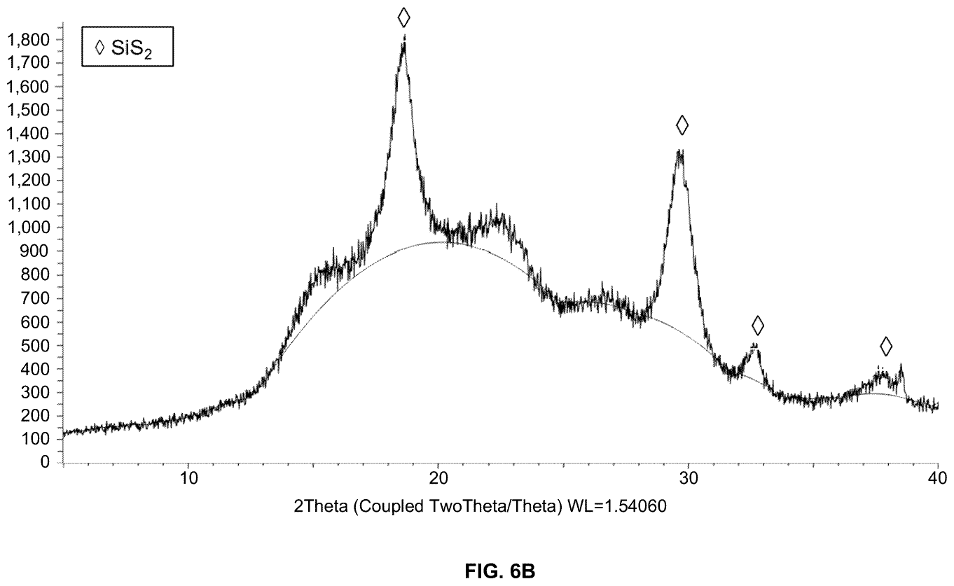

Na₂S and LiCl were added to a glass vial containing 10 mL of acetonitrile where the molar ratio between the Na₂S and the LiCl was 1:2. This mixture was stirred for 12 hours at room temperature, after which, a first precipitate had formed on the bottom of the vial. Without removing this first precipitate, SiCl₄ was added to the vial where the molar ratio between the originally added Na₂S and the SiCl₄ was 2:1. This mixture was stirred for 2 hours at a temperature of 65° C., after which a second precipitate had formed on the bottom of the vial, resulting in a composite containing the first precipitate and the second precipitate. The composite was separated from the solute by way of filtration. The filtered composite was heated to a temperature of 100° C. while under vacuum conditions. The dried composite powder was then scanned using an X-ray diffractometer (XRD) and was identified to be LiCl and NaCl as shown in FIG. 6A.

The solution was added back to the glass vial. Pyridine was added to the glass vial at a volume ratio of 50:50. After the addition of the pyridine, a white powder, third precipitate, precipitated out of solution. The white precipitate was separated from the solute by way of filtering. The filtered third precipitate powder was then heated to 450° C. for 1 hour under vacuum conditions. The heated third precipitate powder was then scanned using an X-ray diffractometer (XRD) and was identified to be SiS2 as shown in FIG. 6B.

### Example 4: Na₂S+SiCl₄

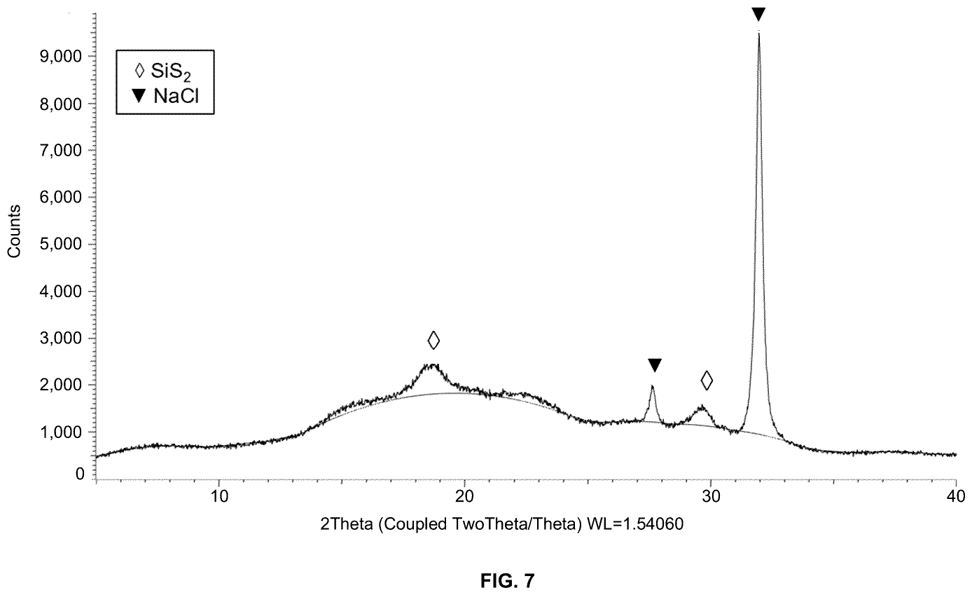

Example 4 was conducted in the same manner as Example 1 except the Li₂S was replaced with Na₂S. The dried first precipitate powder was identified to be SiS₂ and NaCl using an X-ray diffractometer (XRD), as shown in FIG. 7.

### Example 5: Li₂S+SnCl₄

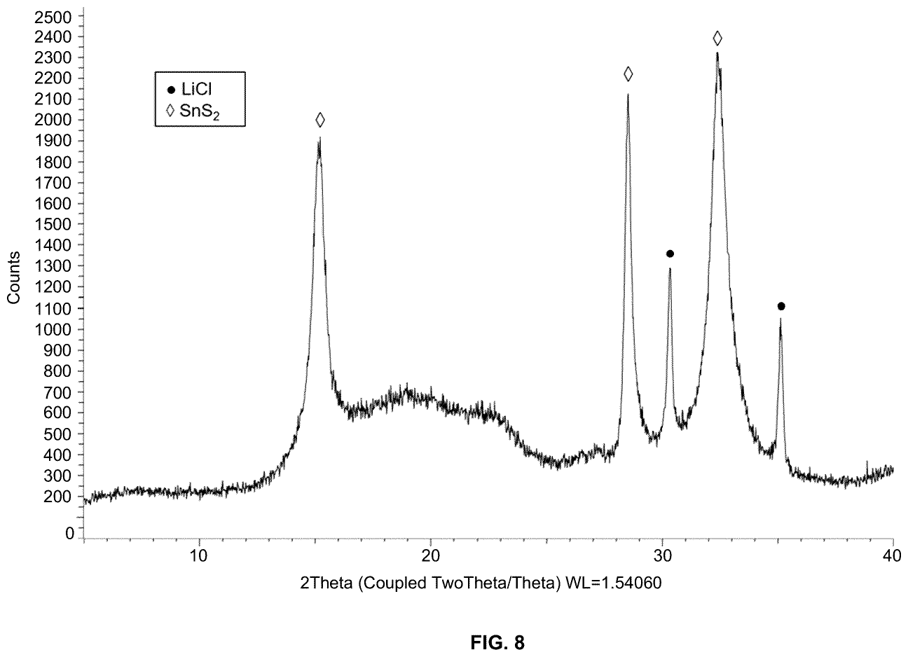

Example 5 was conducted in the same manner as Example 1 except the SiCl₄ was replaced with SnCl₄. The dried first precipitate powder was identified to be SnS₂ and LiCl using an X-ray diffractometer (XRD), as shown in FIG. 8.

### Example 6: Li₂S+ZrCl₄

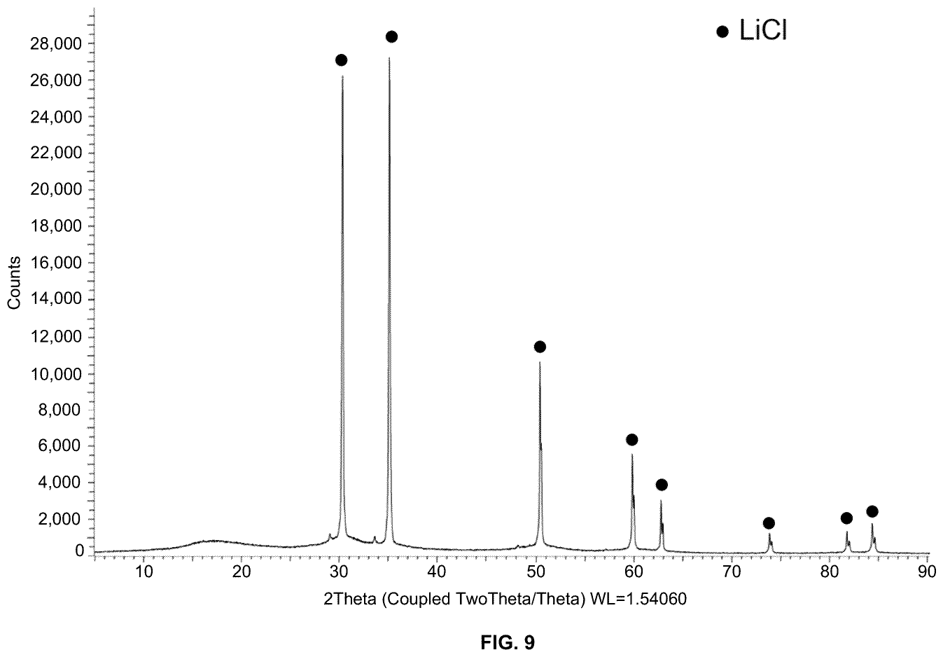

Example 6 was conducted in the same manner as Example 1 except the SiCl₄ was replaced with ZrCl₄. The dried first precipitate powder was identified to be LiCl using an X-ray diffractometer (XRD), as shown in FIG. 9. The presence of LiCl indicates the reaction proceeded. The ZrS₂ may be in a nano form and, as such, does not appear in the XRD plot.

What is claimed is:

1. A method of producing a metal sulfide comprising:
combining a first alkali metal sulfide, a second alkali metal sulfide, and a metal halide in an aprotic solvent to produce a solution comprising a metal sulfide and an alkali metal salt.

2. The method of claim 1, wherein the molar ratio between the first alkali meal sulfide and the second alkali metal sulfide material is from 99:1 to 5:99.

3. The method of claim 1, wherein the first alkali metal sulfide comprises Li₂S, LiNaS, or LiKS.

4. The method of claim 1, wherein the second alkali metal sulfide comprises Na₂S, K₂S, or Cs₂S.

5. The method of claim 1, wherein the metal halide comprises boron, silicon, germanium, antimony, tin, zirconium, or tellurium.

6. The method of claim 1, wherein the metal halide comprises BF₃, BBr₃, BI₃, SiF₄, SiCl₄, SiBr₄, Si₂Cl₆, Si₃Cl₈, GeF₄, GeCl₄, GeBr₄, or GeI₄.

7. The method of claim 1, wherein the aprotic solvent comprises an ether, ester, nitrile, or imine.

8. The method of claim 1, wherein the metal sulfide comprises B₂S₃, SiS₂, or GeS₂.

9. The method of claim 1, wherein the alkali metal salt comprises LiCl.

10. The method of claim 1, wherein the alkali metal salt further comprises LiF, LiBr, LiI, NaF, NaCl, NaBr, NaI, KF, KCl, KBr, KI, CsF, CsCl, CsBr, or CsI.

11. The method of claim 1, wherein the combining comprises mixing, grinding, or tumbling.

12. A method of producing a metal sulfide comprising:
(a) combining a first alkali metal salt and a first alkali metal sulfide in an aprotic solvent to produce a mixture comprising a second sulfide and a precipitated second alkali metal salt;
(b) adding a metal halide to the mixture to produce a supernatant comprising the first alkali metal salt and a metal sulfide and the aprotic solvent;
(c) removing the precipitated second alkali metal salt from the supernatant;
(d) adding a second solvent to precipitate the metal sulfide; and
(e) recovering the precipitated metal sulfide.

13. The method of claim 12, wherein removing the precipitated second alkali metal salt from the supernatant comprises filtering the supernatant.

14. The method of claim 12, wherein the first alkali metal salt comprises LiF, LiCl, LiBr, or LiI.

15. The method of claim 12, wherein the first alkali metal sulfide comprises Li₂S, Na₂S, LiNaS, LiKS, or K₂S.

16. The method of claim 12, wherein the aprotic solvent comprises an ether, ester, nitrile, or imine.

17. The method of claim 12, wherein the second alkali metal sulfide comprises Li₂S, Na₂S, LiNaS, or LiKS.

18. The method of claim 12, wherein the second alkali metal salt comprises NaF, NaCl, NaBr, NaI, KF, KCl KBr, or KI.

19. The method of claim 12, wherein the metal halide comprises BF₃, BBr₃, BI₃, SiF₄, SiCl₄, SiBr₄, Si₂Cl₆, Si₃Cl₈, GeF₄, GeCl₄, GeBr₄, or GeI₄.

20. The method of claim 12, wherein the metal sulfide comprises B₂S₃, SiS₂, or GeS₂.

21. The method of claim 12, wherein the second solvent comprises a hydrocarbon, ether, ester, nitrile, or imine.

22. A method of producing a metal sulfide comprising:
combining a first alkali metal sulfide, a second alkali metal sulfide, and a metal halide in an aprotic solvent to form a mixture comprising a first alkali metal halide, a precipitated second alkali metal halide, and a metal sulfide;
removing the precipitated second alkali metal halide from the mixture;
adding a second solvent to the mixture to precipitate the metal sulfide; and
removing the precipitated metal sulfide from the mixture.

23. A method of producing a composite comprising a metal sulfide comprising:
combining a first alkali metal sulfide, a second alkali metal sulfide, and a metal halide in an aprotic solvent to form a mixture comprising a first alkali metal halide, a precipitated second alkali metal halide, and a metal sulfide;
removing the precipitated second alkali metal halide from the mixture; and
heating the mixture to remove the aprotic solvent, thereby forming a composite comprising a metal sulfide.

24. A method of producing a metal sulfide comprising:
combining an alkali metal sulfide and a metal halide in an aprotic solvent to form a mixture;
adding a second solvent to the mixture to precipitate the metal sulfide; and
removing the precipitated metal sulfide from the mixture.

25. A method of producing a composite comprising a metal sulfide comprising:
combining an alkali metal sulfide and a metal halide in an aprotic solvent to form a mixture; and
heating the mixture to remove the aprotic solvent, thereby forming a composite comprising a metal sulfide.
